(19) United States
(12) Patent Application Publication
(10) Pub. No.: US 2026/0172170 A1
(43) Pub. Date: Jun. 18, 2026

(54) CHANNEL FREQUENCY RESPONSE BASED DISTANCE MEASUREMENT USING FLOATING PILOTS

(71) Applicant: Silicon Laboratories Inc., Austin, TX (US)

(72) Inventors: Kiruba Sankaran Subramani, Austin, TX (US); Yan Zhou, Spicewood, TX (US); Terry L. Dickey, Pflugerville, TX (US)

(21) Appl. No.: 18/984,452

(22) Filed: Dec. 17, 2024

(51) Int. Cl. H04L 5/00; G01S 13/32; G01S 13/70

(52) U.S. Cl. CPC H04L 5/0048; G01S 13/32; G01S 13/70; H04L 5/001; H04L 5/0053

(57) ABSTRACT

Floating pilots are used in an OFDM frame with the subcarrier position of the pilots being determined according to the hopping sequence. The hopping sequence may be, e.g., greater than or equal to one. For example, the hopping sequence may cause each pilot position in the next OFDM symbol to increase by one subcarrier position for each pilot in the next OFDM symbol. The smaller the hopping sequence the smaller the frequency spacing between pilots. There may be, e.g., four pilots in each OFDM symbol. The hopping sequence is modified for a first subcarrier immediately preceding a DC subcarrier and for a second subcarrier immediately following the DC subcarrier. In another approach a random pilot sequence is generated using a key shared between a transmitting and receiving device. A pseudo random number generator may be used to generate the random pilot sequence.

### FIELD OF THE INVENTION

### Description of the Related Art

Achieving accurate distance measurement is becoming an important feature for several use cases for the IEEE 802.11 (Wi-Fi) based wireless local area networks. Several time-of-flight based distance measurement techniques have been proposed for Wi-Fi both from academia and industry. However, those techniques either do not meet the accuracy requirement for certain target use cases or are not scalable to a large network with hundreds of devices that a Wi-Fi network can support.

### SUMMARY OF EMBODIMENTS OF THE INVENTION

Embodiments herein utilize a two-way channel frequency response based distance measurement technique for Wi-Fi that achieves sub-meter distance accuracy and is capable of handling hundreds of devices in a network while supporting the same network throughput achieved by existing Wi-Fi devices.

In an embodiment a method includes shifting a pilot position from a current pilot position in a current subcarrier for a current OFDM symbol in an OFDM frame to a different pilot position in different subcarrier for a next OFDM symbol in the OFDM frame according to a hopping sequence used for a plurality of OFDM symbols in the OFDM frame, wherein the hopping sequence changes the current pilot position to the different pilot position in the next OFDM symbol by a subcarrier index of one or more.

In an embodiment each OFDM symbol has at least four pilots.

In an embodiment the channel frequency response in each data subcarrier is measured across the data subcarriers of a 20 MHz bandwidth channel with 17 OFDM symbols.

In an embodiment the hopping sequence is dynamically changed according to one or more distance measurements for a tracked object. In an embodiment the hopping sequence is increased responsive to the one or more distance measurements indicating the tracked object is moving closer. In an embodiment changing of the hopping sequence is communicated to the tracked object prior to changing the hopping sequence.

In an embodiment a super resolution algorithm is used to estimate a distance between a first device and a second device using amplitude and phase characteristics of a wireless channel over which the first device and the second device communicate, the amplitude and phase characteristics being measured using pilots having positions determined according to the hopping sequence.

In an embodiment a channel frequency response of a channel having a first bandwidth is measured by measuring respective channel responses of channels having bandwidths smaller than the first bandwidth and the channels are overlapping channels that together cover the first bandwidth.

In an embodiment when a number of data symbols needed to be transmitted is insufficient to measure a channel response of a channel, the OFDM frame is padded with additional OFDM symbols to allow measurement of the channel response of the channel.

In another embodiment a method includes utilizing a random pilot sequence while transmitting a plurality of OFDM symbols from a first device to a second device. In an embodiment the method further includes providing a shared key from the first device to the second device. The shared key may be used with a pseudo random number generator to generate the random pilot sequence.

In another embodiment a system includes a first device including a transmitter configured to insert pilots having shifting pilot positions in a sequence of OFDM symbols. The pilot positions shift from a current pilot position in one of a plurality of subcarriers for a current OFDM symbol to a new pilot position in a different one of a plurality of subcarriers for a next OFDM symbol according to a hopping sequence, wherein the hopping sequence is one or more subcarrier positions. The first device further includes a receiver coupled to receive RF signals.

In an embodiment the hopping sequence is N, where is an integer greater than 0.

In an embodiment the hopping sequence is modified when a pilot position falls in the DC subcarrier index, by moving the pilot position to either a first subcarrier immediately preceding the DC subcarrier index or a second subcarrier immediately following the DC subcarrier index.

### BRIEF DESCRIPTION OF THE DRAWINGS

The present invention may be better understood, and its numerous objects, features, and advantages made apparent to those skilled in the art by referencing the accompanying drawings.

FIG. 1 illustrates an embodiment of a wireless communication system.

FIG. 2 is a time frequency plot showing pilot positions in conventional Wi-Fi implementations.

FIG. 3 illustrates an OFDM frame structure.

FIG. 4A is a high level block diagram of a transmitter according to an embodiment.

FIG. 4B is a high level block diagram of a receiver according to an embodiment.

FIG. 5 is a time frequency plot showing floating pilots in which at least one pilot is present in each subcarrier position in the OFDM frame.

FIG. 6 is a time frequency plot showing floating pilots present in every other data subcarrier position.

FIG. 7 is a time frequency plot showing floating pilots present in every fourth data subcarrier position.

FIG. 8 is a time frequency plot showing floating pilots present in every sixth data subcarrier position.

FIG. 9 illustrates a high level block diagram of an embodiment of a system using a secure key.

FIG. 10 illustrates an embodiment of randomized floating pilots providing more secure ranging.

FIG. 11 illustrates an embodiment in which channel response across an 80 MHz bandwidth is measured.

FIG. 12 is a timing diagram of a Wi-Fi ranging solution according to an embodiment.

FIG. 13 illustrates ideal versus measured channel response using floating pilots.

FIG. 14 is an impulse response plot illustrating the effectiveness of floating pilots used with a super resolution algorithm.

The use of the same reference symbols in different drawings indicates similar or identical items.

### DETAILED DESCRIPTION

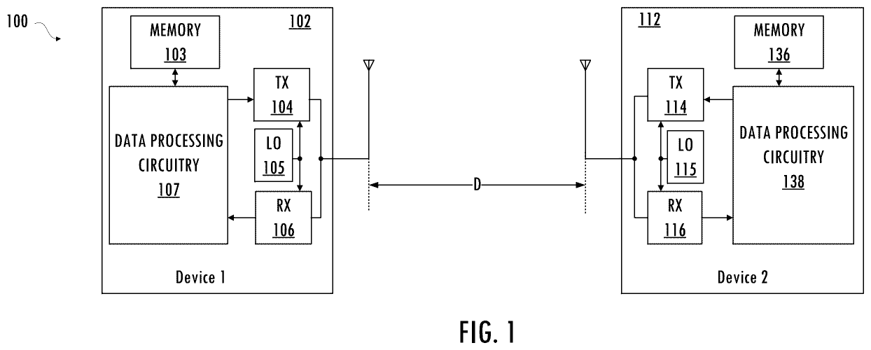

Referring to FIG. 1 a wireless communications system 100 according to an embodiment includes communications device 102, which includes transmitter 104 and receiver 106, and communications device 112, which includes transmitter 114 and receiver 116. A distance D separates communications device 102 from communications device 112. Although communications device 102 and communications device 112 are illustrated as including only one antenna each, in other embodiments, at least one of communications device 102 and communications device 112 include multiple antennas. In an embodiment, wireless communications system 100 is compliant with the 802.11 communications protocol. However, in at least some embodiments, wireless communications system 100 is also compliant with other communications protocols (e.g., Bluetooth Classic, Zigbee, or other short-range radio frequency protocol standards). Local oscillator 105 and local oscillator 115 provide signals used in transceiver functions of communications device 102 and communications device 112, respectively. Data processing circuitry 107 and 138 are respectively coupled to memory 103 and 136. Note that the transmitter and receiver in each communications device may share the data processing circuitry or have dedicated processing circuitry. The data processing circuitry may include one or more processing devices and support digital signal processing required by the transmitter and receiver.

Distance can be measured using a two way phase-based ranging technique. Device 1 sends a transmission to device 2 and device 2 transmits back to device 1, where the packet in the transmission can contain user data determined by the end application. Measuring distance using a two-way phase-based ranging technique can be characterized as shown in Equation 1, where

$$Measured Distance D = \frac{c}{4 {πΔ}_{f}} {Δ}_{Φ} mod \frac{c}{2 {Δ}_{f}} \qquad ( 1 )$$

where “Δ_{f}” represents the frequency separation between the signal tones (between subcarriers in an OFDM system), “C” represents the speed of light and “Δ_{Φ}” represents the phase change of the signal tones observed by the devices, which is a function of the separation distance.

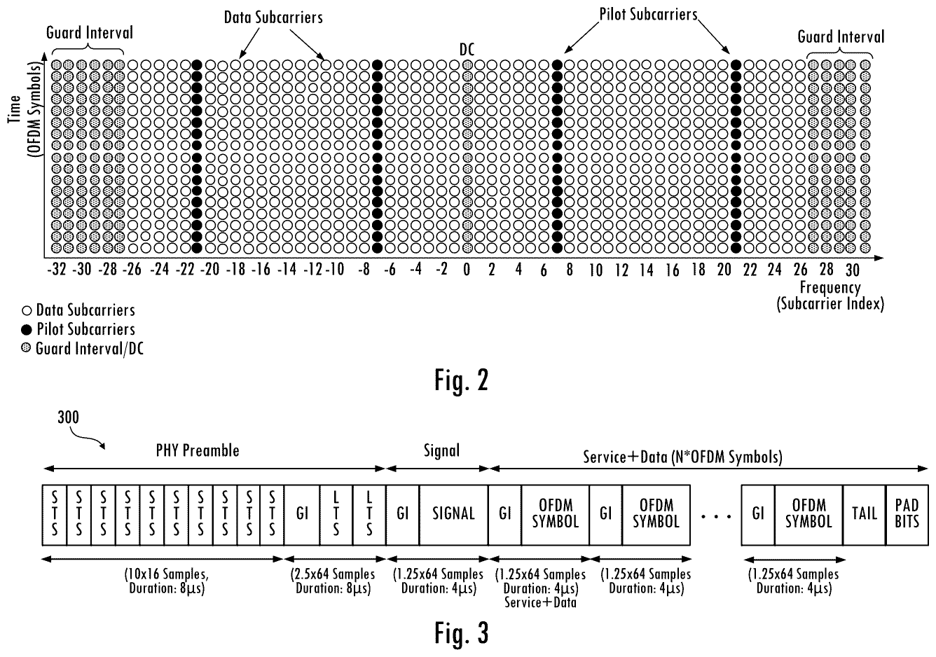

The IEEE 802.11 wireless standard supports an orthogonal frequency division multiplexing (OFDM) physical layer (PHY) among other PHY options. In OFDM, the transmitted information is sent on multiple subcarriers within a wider spectrum. In addition to transmitting data, the transmitter also transmits pilot tones on certain subcarriers to facilitate measurement of the channel frequency response by the receiving device. The pilots transmit known signals to allow channel characteristics to be measured. FIG. 2 illustrates a time frequency plot of a 20 MHz channel divided into 64 subcarriers. Of the 64 subcarriers, 48 are used as data subcarriers, 4 are used as pilots and the remaining 12 are used as guard intervals and DC. The DC subcarrier is the subcarrier having a frequency equal to the RF center frequency and is labeled as subcarrier 0. In FIG. 2, the 4 subcarriers transmitting pilot tones occupy fixed locations, namely subcarrier indices −21, −7, 7 and 21 and have a frequency separation of 4.375 MHz (or 14 subcarrier locations). While that implementation is conventional and works in a traditional Wi-Fi system, for ranging applications where the distance needs to be estimated with high precision, the channel response should be measured at finer frequency intervals and over a large bandwidth. Moreover, the frequency separation between the signal tones (Δ_{f}) in equation 1, also determines the phase wrap around distance in a ranging system. With a smaller frequency separation, e.g., a 312.5 kHz frequency separation, a phase wrap around distance of 480 m can be achieved, which is 3 times better than distance ranging technologies in other wireless standards.

FIG. 3 provides an overview of an OFDM frame 300 used by an embodiment of the system 100. The OFDM frame includes a PHY preamble and a signal field followed by a Data field which is subdivided into numerous OFDM symbols. The PHY preamble includes a short training sequences (STS), a guard interval (GI), and long training sequences (LTS). A guard interval is also included before the signal field and the OFDM symbols. The 802.11 OFDM PHY specification proposes the use of a cyclic prefix in the guard interval to mitigate inter-symbol interference. When using a 20 MHz channel bandwidth, each OFDM symbol is 3.2 μs long and is subdivided into 64 subcarriers that are 312.5 kHz apart. Embodiments leverage the concept of floating pilots, instead of conventional fixed pilot positions shown in FIG. 2, to measure the amplitude and phase characteristics of the wireless channel (channel frequency response) at finer frequency intervals.

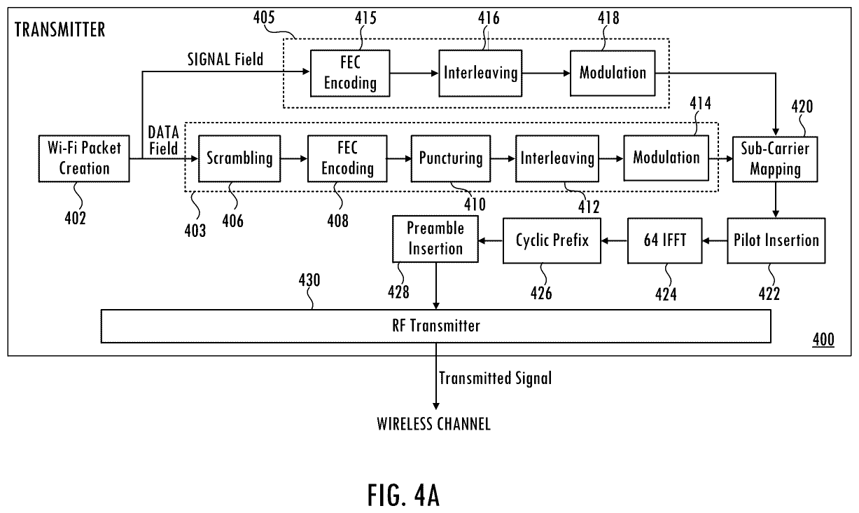

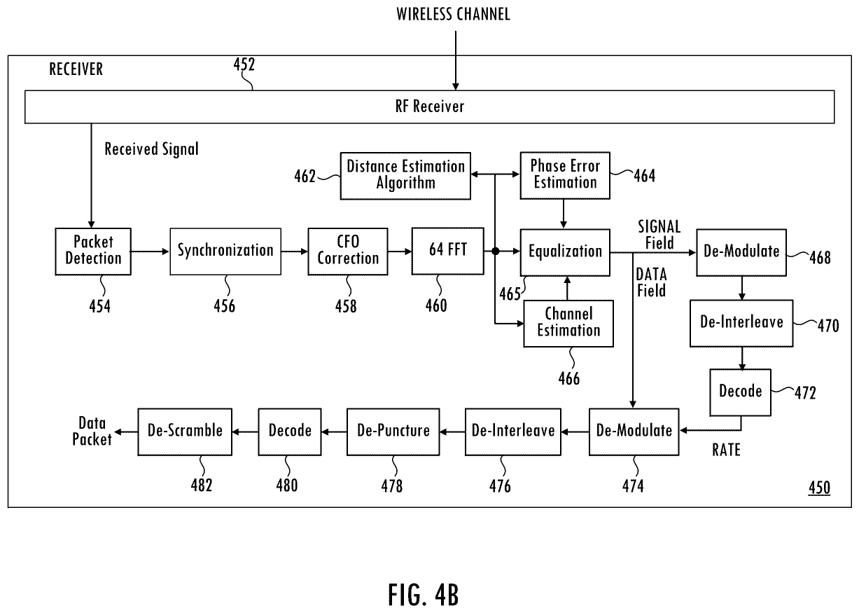

FIGS. 4A and 4B illustrate respectively examples of a transmitter and receiver in devices 102 and 112. The transmitter 400 creates a packet in 402 that includes a Signal field and a Data field. The two fields take separate paths 403 and 405 through the transmitter. The data path includes such standard features as scrambling 406, forward error correction (FEC) encoding 408, puncturing 410, interleaving 412, and modulation 414. The signal path includes similar standard functionality including FEC encoding 415, interleaving 416, and modulation 418. The two streams are joined back together for sub-carrier mapping 420. The pilot insertion block 422 receives the combined streams from sub-carrier mapping. The pilot insertion block 422 inserts the floating pilots as described further herein and supplies the data to the inverse fast Fourier transform (IFFT) block 424. The cyclic prefix is applied in block 426 and the preamble is inserted in block 428 and supplied to RF transmitter block 430, which up-converts the baseband signal to RF and transmits the signal through an antenna (not shown) to the receiving device. Note that the functional blocks described in the transmitter 400 are performed in embodiments by a combination of hardware and software operating on one or more processing devices.

FIG. 4B illustrates a functional block diagram of the receiving device. The receiving device 450 receives the signal through an antenna (not shown) at the RF receiver block 452, which down-converts the RF signal to baseband. The receive path further includes the packet detection block 454, the synchronization block 456, the frequency offset correction block 458 and the FFT block 460. The distance estimation algorithm 462 receives the output of the FFT and provides a distance estimate as described further herein. The FFT block 460 also supplies the phase error estimation block 464, the channel estimation block 466, and the equalization block 465. The output of the equalization block 465 splits into the SIGNAL field and the DATA field. The SIGNAL field is separately demodulated in block 468, de-interleaved in block 470 and decoded in block 472. The decode signal field supplies rate information to demodulate the DATA field in block 474. Block 476 provides de-interleaving, block 478 provides de-puncturing and block 480 decodes the signal field, which is descrambled in block 482. The descramble block 482 provides the data packet. Note that the functional blocks described in the receiver 450 are performed in embodiments by a combination of hardware and software operating on one or more processing devices.

The distance calculation in block 462 resolves the measured channel frequency response to identify the various signal paths between the communicating devices in a multi-path environment. In doing so, the super resolution algorithm sorts out each signal path mathematically to precisely identify the shortest distance between the two devices. Super resolution algorithms are well known in the art and include, e.g., the Matric Pencil Method, the MUSIC (Multiple Signal Classification) method, and ESPRIT (Estimation of Signal Parameters Via Rotational Variance Technique). Example super resolution algorithms are briefly discussed below.

The Matrix Pencil (MP) method converts a non-linear approximation of exponential sums by solving a set of linear equations and a root finding problem. It is defined by f(t, Ψ)=g(t)+Ψh(t), where f( ) is the pencil of g(t) and h(t) parameterized by Ψ. The matrix pencil method uses input MP instead of the correlation matrix. The MP method is based on spatial samples of data and the analysis is done on snapshot-by-snapshot basis. The nonstationary environment can be handled. The Matrix Pencil method finds Direction of Arrival (DOA) in the presence of multi-path coherent signals without performing the addition processing involved with spatial smoothing. However, the method is computation heavy.

Another super resolution algorithm is MUSIC, which is a high resolution subspace based method. MUSIC can provide unbiased estimates of the number of signals, the angles of arrival, and the strengths of the waveforms. MUSIC assumes that the noise in each channel is uncorrelated and the noise correlation matrix is diagonal. Since the incident signals are either somewhat correlated or uncorrelated, the signal correlation matrix is not necessarily diagonal. MUSIC either knows in advance the number of incoming signals or searches the eigenvalues to determine the number of incoming signals. Unlike Discrete Fourier Transforms (DFT)/Inverse Discrete Fourier Transforms (IDFT), MUSIC is able to estimate frequencies with accuracy higher than one sample because its estimation function can be evaluated for any frequency, not just those of DFT bins. That is a form of super resolution. MUSIC outperforms IFFT/IDFT in the presence of noise when the number of components is known in advance. It exploits knowledge of this number to ignore the noise in its output. However, when dealing with a short-time burst signal or fast-moving target signal, only a single snapshot is available, and the performance of parameter estimation is greatly reduced, due to the rank loss of the covariance matrix

$$Rxx = \frac{1}{T} {\sum }_{k = 1}^{T} x ( t ) {x ( t )}^{H} ,$$

where T is number of snapshots. MUSIC also requires a high signal to noise ratio (SNR) (˜20 dB) and has high computation complexity.

The ESPRIT algorithm has significant performance and computational advantages over other algorithms for estimation of arrival angles. ESPRIT is a subspace based direction of arrival (DOA) estimation algorithm. ESPRIT does not perform an exhaustive search through all possible steering vectors to estimate DOA and thus reduces the computational and storage requirements compared to MUSIC. ESPRIT exploits an underlying rotational invariance among signal subspaces induced by an array of sensors with a translational invariance structure. In comparing ESPRIT and MUSIC, the latter is less prone to error compared to ESPRIT for different cases of simulation, i.e. for varying difference in angles between two signals, varying number of antenna elements, different number of signals, different number of samples and different SNR ratio. However, MUSIC is a more computationally intensive algorithm.

Embodiments described herein leverage the concept of floating pilots, instead of conventional fixed pilot positions. The floating pilots are used to measure the amplitude and phase characteristics of the wireless channel (channel frequency response) at finer frequency internals. Thereby, the measured amplitude and phase characteristics are processed by a super resolution algorithm to sort out each signal path mathematically to precisely identify the shortest distance between the two devices.

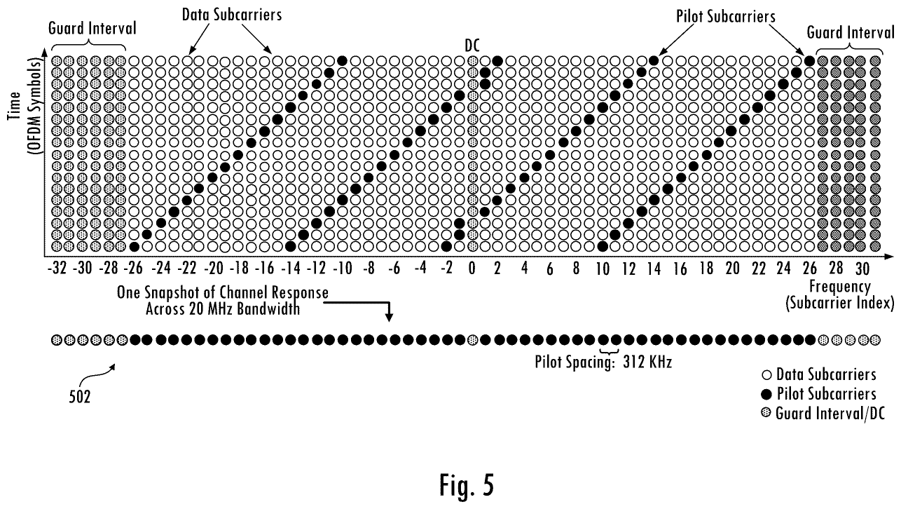

FIG. 5 is a time frequency plot showing at least one of the floating pilots in each data subcarrier in an embodiment using floating pilots. The embodiment leverages the concept of floating pilots, where the pilot positions change continuously between successive OFDM symbols as shown in FIG. 5. The embodiment of FIG. 5 uses a hopping sequence of 1. That is the subcarrier index is increased by one for each OFDM symbol, e.g., from a subcarrier index of −25 to a subcarrier index of −24. The exception is around DC. In the figure, each OFDM symbol uses a total of 4 pilot subcarriers similar to the current Wi-Fi implementation. However, the pilot positions are shifted by one subcarrier position (where possible) between successive OFDM symbols such that the channel response is measured across the entire frequency band with a frequency resolution of 312.5 KHz. Of course, the DC subcarrier (subcarrier 0) cannot be used for a pilot and thus the pilot position that would otherwise be in DC is shifted to the left or to the right to be in subcarrier −1 or 1.

The embodiment illustrated in FIG. 5 requires 17 OFDM symbols to measure the channel response across a 20 MHz channel (16.25 MHz excluding subcarriers associated with DC and guard intervals) and incurs a latency of 88 μs (20 μs for the packet preamble and signal fields and 68 us for the 17 OFDM data symbols with guard intervals). FIG. 5 shows one snapshot of the channel response across the 20 MHz bandwidth at 502 with a pilot spacing of 312 kHz. Note that the hopping sequence (increasing by one subcarrier index) is used for all the pilots in each OFDM symbol in the OFDM frame. Thus, the pilots at (−24, −12, 4, and 12) for the third OFDM symbol are increased by one to (−23, −11, 5, and 13) for the fourth OFDM symbol. As can be seen in FIG. 5, the hopping sequence around DC is modified.

The frequency response of a multipath channel can be modeled as shown in equation 2, where Ny denotes the number of signal paths, αᵢ is the gain (attenuation) and τᵢ is the delay of each of the signal paths, Δ_{f} is the subcarrier spacing, e.g., 312 kHz as shown in FIG. 5, and N_{sc} is the subcarrier index ((−32 to +31) in the embodiment illustrated in FIG. 5).

$$H ( f ) = {\sum }_{i = 1}^{{N}_{p}} {α}_{i} {e}^{- j 2 π ( {f}_{c} + ( {Δ}_{f} * {N}_{SC} ) ) {τ}_{i}} \qquad ( 2 )$$

The transmitted and received baseband signals S(f) and R(f) can be modeled as shown in equation 3 and equation 4 respectively, where Xₖ is the modulated baseband data that gets mapped onto the subcarrier within each OFDM symbol and W represents the complex additive white Gaussian noise (AWGN) in the system.

$$S ( f ) = {\sum }_{k = 0}^{{N}_{SC}} {X}_{k} {e}^{j 2 π ( k * {Δ}_{f} )} \qquad ( 3 )$$

$$R ( f ) = H ( f ) \cdot S ( f ) + W \qquad ( 4 )$$

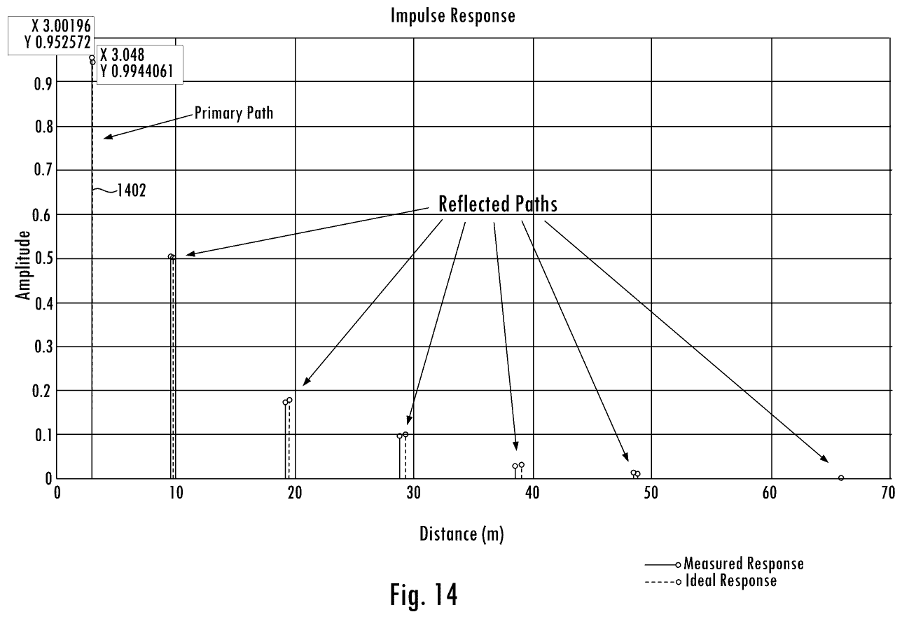

Embodiments described herein use information from the floating pilots to obtain an estimate H′(f) of the channel frequency response H(f) and that channel frequency response estimate H′(f) is supplied to the super resolution algorithm. The super resolution algorithm decomposes the received estimate H′(f) into Np paths, each with its own time delay factor Ti and each path having a particular amplitude and the super resolution algorithm outputs the impulse response shown in FIG. 14 which contains various distance estimates. Thereby, the path with the smallest time delay factor, shown as distance in the impulse response, and which has the largest amplitude is selected as the distance between the devices.

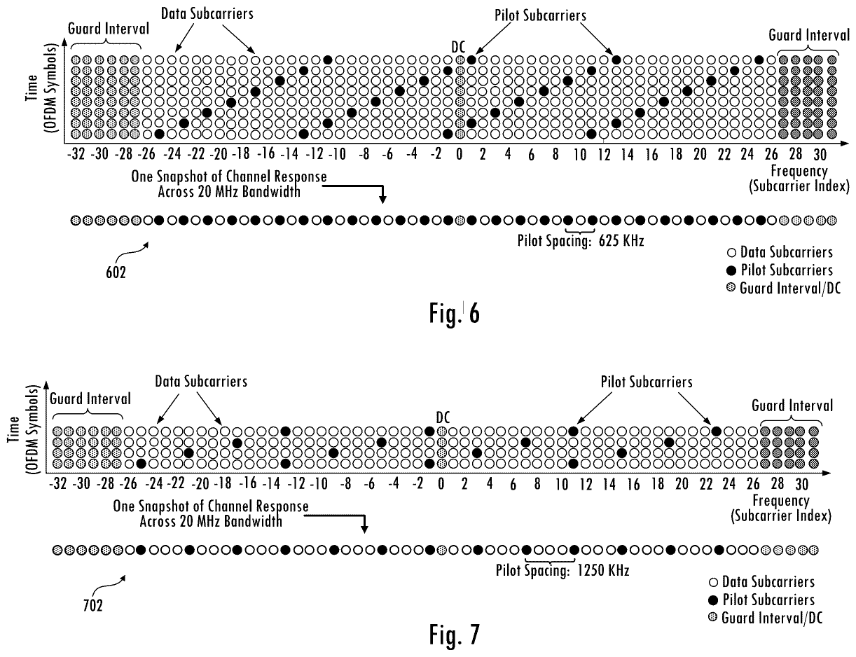

There is a tradeoff between latency, frequency resolution, and phase wrap around distance and to this end, other embodiments utilize fewer pilot positions to provide a faster update to channel state. A faster update to channel state information provides more accuracy for a moving object being tracked. FIG. 6 illustrates a time frequency plot showing the floating pilots occupying every other subcarrier position, i.e., a hopping sequence of 2. Thus, with a 20 MHz channel bandwidth, and with the floating pilots having a subcarrier spacing of 2, the embodiment requires 8 OFDM symbols to measure the channel response with a latency of 52 μs (20 μs for the packet preamble and signal fields and 32 μs for the 8 OFDM data symbols with guard intervals). Note the pilot overlap at subcarriers (−13, −11, 11, 13) to ensure four pilots per OFDM symbol. These overlapping pilots help determine whether the channel is fast fading or slow fading and help improve distance accuracy when dealing with fast moving objects. FIG. 6 shows one snapshot of the channel response across the 20 MHz bandwidth at 602 with a pilot spacing of 625 kHz.

FIG. 7 illustrates a time frequency plot showing the floating pilots occupying every fourth subcarrier position i.e., a hopping sequence of 4. Note the pilot overlap at subcarrier positions −13 and 13 have two pilots to ensure four pilots per OFDM symbol. With a 20 MHz channel bandwidth, and with the floating pilots having a subcarrier spacing of 4, the embodiment requires 4 OFDM symbols to measure the channel response with a latency of 36 μs (20 μs for the packet preamble and signal fields and 16 μs for the 4 OFDM data symbols with guard intervals). FIG. 7 shows one snapshot of the channel response across the 20 MHz bandwidth at 702 with a pilot spacing of 1250 kHz.

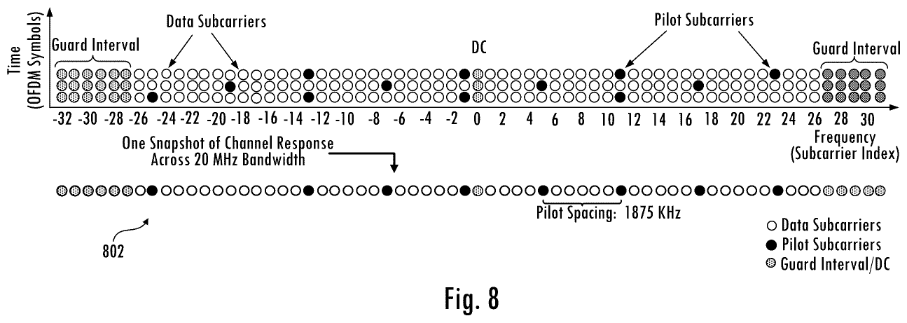

FIG. 8 shows another floating pilot embodiment in which the pilots are separated by 6 subcarrier positions i.e., a hopping sequence of 6, requiring 3 OFDM symbols and 32 μs (20 μs for the packet preamble and signal fields and 12 μs for the 3 OFDM data symbols with guard intervals) to measure the channel response. Note the pilot overlap at subcarriers (−13, 11) to ensure four pilots per OFDM symbol. FIG. 8 shows one snapshot of the channel response across the 20 MHz bandwidth at 802 with a pilot spacing of 1875 kHz. Of course, other pilot spacing options with a different hopping sequence can also be used depending on the accuracy and latency needs of the target application.

While the embodiments illustrated in FIGS. 5-8 use a deterministic sequence for the pilot positions within successive OFDM symbols, the ranging procedure can be made more secure by randomizing the pilot sequence. FIG. 9 illustrates a high level block diagram of a secure system 900 in which the pilots are randomized according to a secure key. In the system 900 a secure key is shared between the devices 902 and 904, and the secure key is used to create a pseudo random sequence, which in turn determines the pilot positions within the OFDM symbols. Note that many other cryptographic algorithms can be used to securely generate the random pilot sequence in the transmitter, which in turn is known by the receiver.

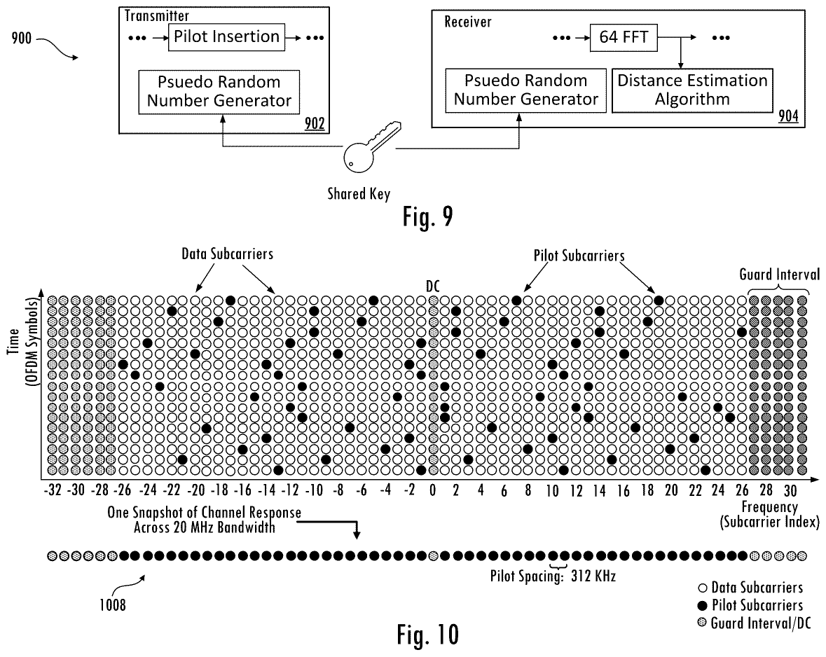

FIG. 10 illustrates a time frequency plot showing the floating pilots occupying random subcarrier position. Thus, with a 20 MHz channel bandwidth, the embodiment requires 17 OFDM symbols to measure the channel response with a latency of 88 μs (20 μs for the packet preamble and signal fields and 68 μs for the 17 OFDM data symbols with guard intervals). That does not include the transmission of the shared key. FIG. 10 shows one snapshot of the channel response across the 20 MHz bandwidth at 1008 with a pilot spacing of 312 kHz. While the example shown in FIG. 10 has at least one pilot symbol in each subcarrier, other randomized approaches can also be used. Thus, the pilot positions shown in FIGS. 6-8 can also be randomized using shared key along with randomization of other pilot spacing options not shown. Note that the hopping sequence and randomization may require negotiation between devices to ensure that the devices support the particular hopping sequence and/or randomization desired by the station doing the distance measurement.

The channel frequency response based ranging solution for Wi-Fi, leveraging the concept of floating pilots along with super resolution algorithm can achieve sub-meter level ranging accuracy. The solution uses both the amplitude and phase characteristics of the wireless channel to estimate the distance unlike traditional approaches that only rely on the phase characteristics, thereby making it more resilient against multipath. Embodiments using floating pilots and super resolution algorithms have better distance resolution and measurement stability compared with receive signal strength indicator (RSSI) and traditional phase based Time-of-Flight (TOF) distance measurement techniques. Embodiments described herein can perform hundreds of distance measurements per second and thereby scale to handling a wireless network with greater than 100 devices. Embodiments provide secure ranging by controlling the pilot positions within the OFDM symbols using a shared key and a pseudo random number generator. Embodiments can scale to different channel bandwidths and carrier frequencies. Note floating pilots and/or shared key approaches can also be used with more traditional approaches that use only phase characteristics of the channel.

The embodiments illustrated above provide different latencies according to the number of OFDM symbols required to measure the 20 MHz bandwidth. While tracking objects to determine location of the object, e.g., in a logistics application, a faster update to channel state information gives more accuracy for a moving object. Thus, assume for example, if the object being tracked is far away based on a current distance estimation, then it is preferable to use finely spaced subcarriers, e.g., with a minimum pilot spacing for distance estimation. If the tracked object is close, then it is preferable to use subcarriers that are farther apart. That can be accomplished by dynamically changing the pilot spacing, thereby trading off the measurement range or phase wrap around distance for measurement latency. Of course a change in pilot spacing needs to be communicated to the object being tracked. Thus, one can start out with a pilot spacing of 312 kHz and change to a pilot spacing of, e.g., 625 kHz or 1250 kHz, as the tracked object distance gets smaller.

Rather than changing the hopping sequence, another approach would be to maintain, e.g., the minimum pilot spacing of 312 kHz (hopping sequence of 1) and change the pairs of subcarriers used by the algorithm to determine distance. That approach can result in a longer latency for faster moving objects. For a tracked object that is far away, multiple redundant measurements can be made with adjacent pairs of subcarriers. For a tracked object that is closer, the frequency separation of the subcarriers used is increased to improve measurement latency at shorter distances.

Note that if the amount of data to be sent is less than that required to measure the desired bandwidth, e.g., 20 MHz, the packet can be extended by padding to thereby include the number of OFDM symbols needed to measure the bandwidth desired. The pad bits as defined in IEEE 802.11 pad 0's to ensure that the last segment of user data occupies an OFDM symbol. That takes the selected modulation scheme into account to determine how many 0s to pad to the OFDM symbol. In order to pad to measure the bandwidth desired, one or more embodiments sets the length field in the Physical Layer Convergence Procedure (PLCP) header to the number needed for channel frequency response measurement and uses 802.11's pad bits feature to pad all the data carriers needed while leveraging floating pilots to measure the channel frequency response. In an embodiment, the padded bits utilize pseudo random data rather than 0s so that the entire channel frequency response can be measured using fewer OFDM symbols. If additional OFDM symbols are being padded, that information is communicated to the receiver, e.g., in the header or a header extension or another mechanism, so that the receiver ignores the payload except for purposes of measuring the channel frequency response.

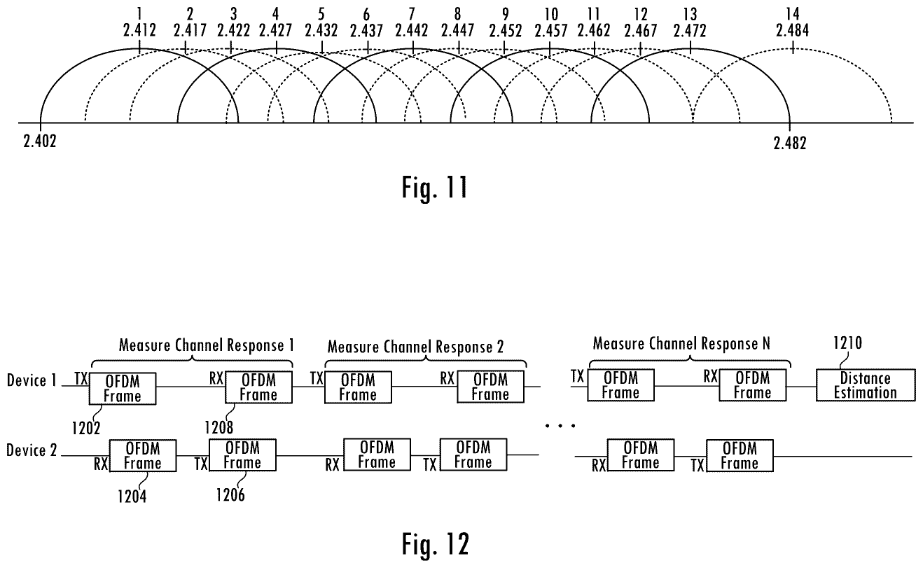

In addition to measuring the channel response at finer frequency intervals, measuring channel response across a wider channel bandwidth can also be advantageous. To this end, in an embodiment the channel response across an 80 MHz bandwidth is measured, as shown in FIG. 11, although the solution can also be implemented using other channel bandwidth options such as 20 MHz, 40 MHz, 160 MHz and 320 MHz, respectively. FIG. 11 shows 14 Wi-Fi channels (channels 1-11 available in the U.S.). The channels are each 20 MHz. In the embodiment illustrated in FIG. 11, the channel response across overlapping Wi-Fi channels is measured covering the frequency range from 2.402 GHz to 2.482 GHz. Overlapping channels 1, 4, 7, and 10 can be used to measure U.S. WiFi channels and channel 13 can be added to get to the full 80 MHz bandwidth. Note that overlap between the channels being measured allows the channel response of subcarriers that are guard bands in one channel but not another to be measured.

After the entire bandwidth is measured, the measured amplitude and phase response of the channel is processed using a super resolution algorithm to estimate the distance between the devices. Alternatively, the response of 40 MHz, 80 MHz, 160 MHz and 320 MHz channel options can also be measured using communication supporting wider channel bandwidth options, thereby further reducing the corresponding latency.

FIG. 12 shows an exemplary timing diagram for Wi-Fi ranging embodiments described herein. Device 1 transmits an OFDM frame at 1202 to device 2, which receives the OFDM frame at 1204 and transmits an OFDM frame at 1206. Device 1 then receives the OFDM frame transmitted from Device 2 at 1208 to complete measurement of the channel response 1. The sequence is repeated to measure the next channel response 2 and repeated for up to N channel response measurements. The distance estimation is then completed in 1210. Of course, N can range from 1 up to the number of channel responses desired, e.g., to cover a wider bandwidth channel.

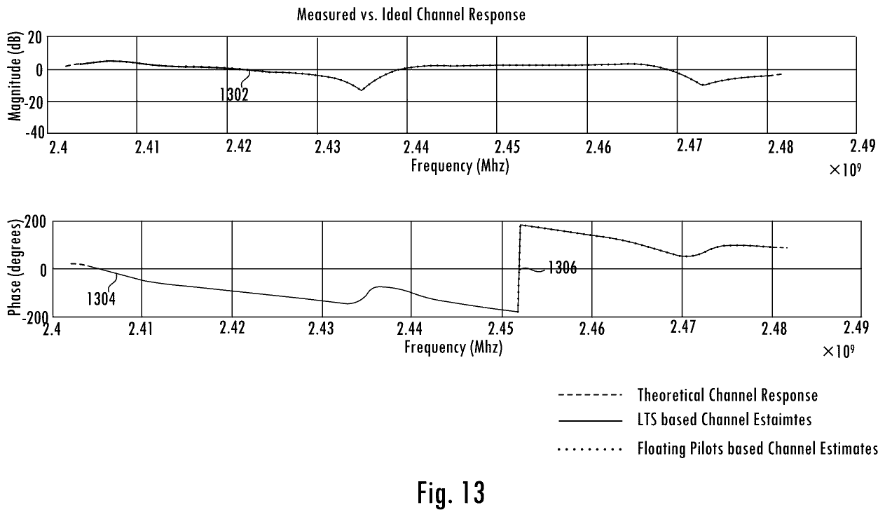

FIG. 13 illustrates an evaluation of an embodiment of the floating pilots approach evaluated using a multi tap wireless channel model and in the presence of noise. The measured versus ideal channel response magnitude is shown at 1302. The evaluation shows that the theoretical channel response, the LTS based channel estimates and the floating pilots based channel estimates all coincide. The measured versus ideal channel response phase is shown at 1304. The theoretical channel response, LTS based channel estimates, and the floating pilots based channel estimates all coincide. A 180 degree wrap is shown at 1306.

FIG. 14 shows the impulse response comparing the ideal vs. measured response and illustrates the output of the super resolution algorithm. In FIG. 14, the primary path corresponds to the distance between the two devices, which is 3.048 m. The distance measured by using a super resolution algorithm is 3.00196 m. The higher amplitude shown at 1402 indicates the primary path while the lower amplitudes indicating different distance measurement are reflected paths. The resulting distance error of 46 cm highlights the effectiveness of using the floating pilots and a super resolution algorithm to accurately estimate the distance under multipath conditions.

Thus, techniques for using floating pilots to measure channel characteristics have been described. The description of the invention set forth herein is illustrative and is not intended to limit the scope of the invention as set forth in the following claims. The terms “first,” “second,” “third,” and so forth, as used in the claims, unless otherwise clear by context, are to distinguish between different items in the claims and do not otherwise indicate or imply any order in time, location or quality. Variations and modifications of the embodiments disclosed herein may be made based on the description set forth herein, without departing from the scope of the invention as set forth in the following claims.

What is claimed is:

1. A method comprising:
shifting a pilot position from a current pilot position in a current subcarrier for a current OFDM symbol in an OFDM frame to a different pilot position in different subcarrier for a next OFDM symbol in the OFDM frame according to a hopping sequence used for a plurality of OFDM symbols in the OFDM frame, wherein the hopping sequence changes the current pilot position to the different pilot position in the next OFDM symbol by a subcarrier index of one or more.

2. The method as recited in claim 1 wherein each OFDM symbol has at least four pilots.

3. The method as recited in claim 1 further comprising measuring a channel response in each data subcarrier across a 20 MHz bandwidth with 17 OFDM symbols.

4. The method as recited in claim 1 dynamically changing the hopping sequence according to one or more distance measurements for a tracked object.

5. The method as recited in claim 4 further comprising increasing the hopping sequence responsive to the one or more distance measurements indicating the tracked object is moving closer.

6. The method as recited in claim 5 further comprising communicating the changing of the hopping sequence to the tracked object.

7. The method as recited in claim 1 further comprising using a super resolution algorithm to estimate a distance between a first device and a second device using amplitude and phase characteristics of a wireless channel over which the first device and the second device communicate, the amplitude and phase characteristics being measured using pilots having positions determined according to the hopping sequence.

8. The method as recited in claim 1 further comprising:
measuring a channel response of a channel having a first bandwidth by measuring respective channel responses of channels having bandwidths smaller than the first bandwidth and the channels are overlapping channels that together cover the first bandwidth.

9. The method as recited in claim 8 wherein the first bandwidth is 80 MHz and the overlapping channels have bandwidths that are 20 MHz.

10. The method as recited in claim 1 wherein where a number of data symbols needed to be transmitted is insufficient to measure a channel response of a channel, the OFDM frame is padded with additional OFDM symbols to allow measurement of the channel response of the channel.

11. A method comprising utilizing a random pilot sequence while transmitting a plurality of OFDM symbols from a first device to a second device.

12. The method as recited in claim 11 further comprising providing a shared key from the first device to the second device.

13. The method as recited in claim 11 further comprising using a pseudo random number generator to generate the random pilot sequence.

14. A system comprising:
a first device including a transmitter configured to insert pilots having shifting pilot positions in a sequence of OFDM symbols, the pilot positions shifting from a current pilot position in one of a plurality of subcarriers for a current OFDM symbol to a new pilot position in a different one of a plurality of subcarriers for a next OFDM symbol according to a hopping sequence, wherein the hopping sequence is one or more subcarrier positions; and
wherein the first device further includes a receiver coupled to receive RF signals.

15. The system as recited in claim 14 wherein each OFDM symbol has at least four pilots.

16. The system as recited in claim 14 wherein the hopping sequence is changed according to one or more distance measurements for a tracked object.

17. The system as recited in claim 14 wherein the hopping sequence is communicated to a second device.

18. The system as recited in claim 14 wherein the first device estimates distance to a second device using a super resolution algorithm that uses channel frequency responses of subcarriers determined using the pilots having shifting pilot positions.

19. The system as recited in claim 14 wherein the hopping sequence is N, where N is an integer greater than 0.

20. The system as recited in claim 14 wherein when a pilot position falls in the DC subcarrier index, the hopping sequence is modified by moving the pilot position to either a first subcarrier immediately preceding a DC subcarrier index or to a second subcarrier immediately following the DC subcarrier index.
